(19) United States
(12) Patent Application Publication
(10) Pub. No.: US 2012/0231262 A1
(43) Pub. Date: Sep. 13, 2012

(54) ELECTRODE MATERIAL FOR ALUMINUM ELECTROLYTIC CAPACITOR AND PRODUCTION METHOD THEREFOR

(75) Inventors: Shinya Sone, Osaka-shi (JP); Toshifumi Taira, Osaka-shi (JP); Masashi Mehata, Osaka-shi (JP)

(73) Assignee: TOYO ALUMINIUM KABUSHIKI KAISHA, Osaka-shi, Osaka (JP)

(21) Appl. No.: 13/510,711

(22) PCT Filed: Nov. 25, 2010
(86) PCT No.: PCT/JP2010/071048

§ 371 Date: May 18, 2012

(30) Foreign Application Priority Data
Dec. 8, 2009 (JP) 2009-278415
Nov. 8, 2010 (JP) 2010-249502

(51) Int. Cl. B32B 5/16; B22F 7/00

(52) U.S. Cl. 428/328; 419/6

(57) ABSTRACT

The present invention provides an electrode material for aluminum electrolytic capacitors and a production method thereof. The electrode material of the present invention is formed of a sintered body of at least one of aluminum or aluminum alloys, and does not require an etching process. The electrode material of the present invention ensures a high capacitance even when the aluminum or aluminum alloy powder has a small particle diameter and the sintered body has a large thickness. Specifically, the present invention provides an electrode material for aluminum electrolytic capacitors, comprising a sintered body of at least one of an aluminum powder and aluminum alloy powders, wherein: the powder has an average particle diameter d50 of 1 to 10 μm, and the sintered body comprises two or more sintered layers in which average particle diameters d50 of powders contained in adjacent sintered layers have a difference of at least 0.5 μm.

### TECHNICAL FIELD

The present invention relates to an electrode material used for an aluminum electrolytic capacitor, particularly a positive electrode material used for a medium- to high-voltage aluminum electrolytic capacitor, and a method for producing the electrode material.

### BACKGROUND ART

The main capacitors currently in use include aluminum electrolytic capacitors, tantalum electrolytic capacitors, and ceramic capacitors.

Ceramic capacitors are produced by sandwiching a barium titanate dielectric between precious metal plates, and then sintering. Ceramic capacitors, which have a thick dielectric, have a lower capacitance than aluminum electrolytic capacitors and tantalum electrolytic capacitors. However, ceramic capacitors are characteristically small in size, and have difficulty generating heat.

Tantalum electrolytic capacitors comprise a tantalum powder and an oxide film formed thereon. Tantalum electrolytic capacitors characteristically have a capacitance lower than that of aluminum electrolytic capacitors and higher than that of ceramic capacitors; and are less reliable than ceramic capacitors, but more reliable than aluminum electrolytic capacitors.

Based on such characteristic differences, ceramic capacitors are, for example, used for compact electronics such as cellular phones; tantalum electrolytic capacitors are used for household electric appliances, such as televisions; and aluminum electrolytic capacitors are used for inverter power supplies for hybrid vehicles, and for storage of wind-generated electricity.

As described above, aluminum electrolytic capacitors have been widely used in the field of energy due to their characteristic properties. Aluminum foil is generally used as an electrode material for aluminum electrolytic capacitors.

The surface area of an electrode material for an aluminum electrolytic capacitor can usually be increased by performing an etching treatment to form etching pits. The etched surface of the electrode material is then anodized to form thereon an oxide film, which functions as a dielectric. Accordingly, by etching the aluminum foil and applying to the surface thereof one of various voltages selected to match the voltage to be used so as to form an aluminum anodic oxide film, various aluminum anodes (foils) for electrolytic capacitors that are suited to specific applications can be produced.

In the etching process, pores called etching pits are formed in an aluminum foil. The etching pits are formed into various shapes, according to the anodizing voltage applied.

More specifically, a thick oxide film must be formed for use in medium- to high-voltage capacitors. Therefore, in order to prevent etching pits from being buried by such a thick oxide film, etching pits of an aluminum foil for medium- to high-voltage anodes are shaped into a tunnel, mainly by conducting direct-current etching; and then formed to an appropriate thickness according to the voltage applied. In contrast, small etching pits are necessary for use in low-voltage capacitors. Therefore, sponge-like etching pits are formed mainly by alternating-current etching. The surface area of a cathode foil is similarly increased by etching.

However, these etching treatments require the use of an aqueous hydrochloric acid solution that contains sulfuric acid, phosphoric acid, nitric acid, etc., in hydrochloric acid. More specifically, hydrochloric acid leads to increased environmental burden, and its disposal is also a burden on the production process and on the economy. Therefore, the development of a novel method for increasing the surface area of an aluminum foil, which does not require etching, has been in demand.

In order to meet this demand, an aluminum electrolytic capacitor characterized by using an aluminum foil having a fine aluminum powder adhering to the surface thereof has been proposed (see, for example, Patent Literature (PTL) 1). Another example of a known electrolytic capacitor is one that uses an electrode foil that comprises a flat aluminum foil having a thickness of not less than 15 μm but less than 35 μm, wherein an aggregate of self-similar aluminum fine particles having a length of 2 to 0.01 μm and/or aluminum fine particles having an aluminum oxide layer formed on the surface thereof is adhered to one or both surfaces of the flat aluminum foil (Patent Literature (PTL) 2).

However, the methods disclosed in the aforementioned documents, wherein aluminum powder is adhered to the aluminum foil by plating and/or vacuum evaporation, are insufficient, at least for obtaining a substitute for thick etching pits for medium- to high-voltage capacitors.

Further, as an electrode material for aluminum electrolytic capacitors that does not require etching, an electrode material for aluminum electrolytic capacitors comprising a sintered body of at least one of aluminum and aluminum alloys is disclosed (see, for example, Patent Literature (PTL) 3). This sintered body has a unique structure formed by sintering aluminum or aluminum alloy powder particles while maintaining a space between each particle; therefore, the sintered body is considered to have a capacitance that is equivalent to or higher than that of a conventional etched foil (paragraph [0012] of Patent Literature (PTL) 3).

However, the electrode material disclosed in Patent Literature (PTL) 3 has a disadvantage in that, when using an aluminum powder or aluminum alloy powder having a small particle diameter (e.g., average particle diameter D₅₀ of 1 to 10 μm), it is difficult to control the space formed between each particle. Accordingly, there arise problems such that the space may be narrowed or buried upon formation of an anodic oxide film by application of various voltages; thus, it is difficult to obtain a desired electric capacitance. In particular, this problem tends to occur when the anodic oxide film is formed at a high voltage, or when the sintered body has a large thickness.

### CITATION LIST

### Patent Literature

PTL 1: Japanese Unexamined Patent Publication No. H2-267916

PTL 2: Japanese Unexamined Patent Publication No. 2006-108159

PTL 3: Japanese Unexamined Patent Publication No. 2008-98279

### SUMMARY OF INVENTION

### Technical Problem

An object of the present invention is to provide an electrode material for aluminum electrolytic capacitors formed of a sintered body of at least one of aluminum or aluminum alloys; and a production method thereof. The electrode material for aluminum electrolytic capacitors of the present invention does not require an etching process, and ensures a high capacitance even when the aluminum powder or aluminum alloy powder has a small particle diameter and the sintered body has a large thickness.

### Solution to Problem

The inventors of the present invention conducted extensive research to attain the above object, and found that the above object can be accomplished by forming a sintered body comprising specific two or more sintered layers using at least one of an aluminum powder and aluminum alloy powders. With this finding, the inventors completed the present invention.

The present invention relates to the following electrode material for aluminum electrolytic capacitors, and manufacturing methods thereof.

1. An electrode material for aluminum electrolytic capacitors, comprising a sintered body of at least one of an aluminum powder and aluminum alloy powders, wherein:

(1) the powder has an average particle diameter D₅₀ of 1 to 10 μm,

(2) the sintered body comprises two or more sintered layers in which average particle diameters D₅₀ of powders contained in adjacent sintered layers have a difference of at least 0.5 μm.

2. The electrode material for aluminum electrolytic capacitors according to Item 1, further comprising a substrate that supports the electrode material.
3. The electrode material for aluminum electrolytic capacitors according to Item 2, wherein the substrate is an aluminum foil.
4. The electrode material for aluminum electrolytic capacitors according to Item 2 or 3, wherein the sintered body is formed on each side of the substrate, and wherein:

(1) the sintered body formed on each side has a thickness of 35 to 500 μm, and

(2) each layer of the sintered body formed on each side of the substrate has a thickness of not less than 15 μm.

5. A method for producing an electrode material for aluminum electrolytic capacitors, wherein the method does not comprise an etching step, and comprises,

(1) a first step of laminating two or more layers formed of a composition of at least one of an aluminum powder and aluminum alloy powders on a substrate; and

(2) a second step of sintering the two or more layers at 560° C. to 660° C.,

and wherein (i) the powder contained in each of the layers has an average particle diameter D₅₀ of 1 to 10 μm, and (ii) average particle diameters D₅₀ of powders contained in adjacent sintered layers have a difference of at least 0.5 μm.

6. The method according to Item 5, wherein the two or more layers are formed on each side of the substrate.
7. The method according to Item 5 or 6, further comprising a third step of anodizing the two or more layers after sintering.

### Advantageous Effects of Invention

The electrode material for aluminum electrolytic capacitors of the present invention comprises a sintered body of at least one of an aluminum powder and aluminum alloy powders, wherein the sintered body is formed of two or more specific sintered layers. With this structure, the electrode material for aluminum electrolytic capacitors of the present invention ensures a high capacitance even when the aluminum or aluminum alloy powder has a small particle diameter and the sintered body has a large thickness.

### BRIEF DESCRIPTION OF DRAWINGS

FIG. 1 A drawing showing different types of sintered layers formed of the electrode materials produced in Comparative Examples 1 and 2 and Examples 1 to 3. Al represents aluminum foil (substrate). The values “3 μm” and “4 μm” are average particle diameters D₅₀ of respective aluminum powders contained in the sintered layers. Nos. 1, 2, 3, 4 and 5 denote Comparative Example 1, Comparative Example 2, Example 1, Example 2 and Example 3, respectively.

FIG. 2 Images showing observation results of cross sections (above the Al substrates) of the electrode materials produced in Comparative Examples 1 and 2 and Example 3, taken by a scanning electron microscope. From left to right, the results of Comparative Example 1, Comparative Example 2, and Example 3 are shown. The vertically divided three images respectively show, from top to bottom, a region near the surface, a central region, and a region near the substrate of the electrode material.

### DESCRIPTION OF EMBODIMENTS

### 1. Electrode Material for Aluminum Electrolytic Capacitors

The electrode material for aluminum electrolytic capacitors of the present invention is formed of a sintered body comprising at least one of an aluminum powder and aluminum alloy powders, and is characterized in that:

(1) the powder has an average particle diameter D₅₀ (before sintering) of 1 to 10 μm; and
(2) the sintered body is formed of two or more sintered layers, and average particle diameters D₅₀ (before sintering) of powders contained in adjacent sintered layers have a difference of at least 0.5 μm.

The electrode material of the present invention having such a structure ensures a high capacitance, even when the aluminum or aluminum alloy powder has a small particle diameter and the sintered body has a large thickness.

For example, a pure aluminum powder having a purity of 99.8 wt % or more is preferably used as the material of the sintered body. Further, preferable examples of aluminum alloy powders used as the material include alloys containing one or more elements selected from silicon (Si), iron (Fe), copper (Cu), manganese (Mn), magnesium (Mg), chrome (Cr), zinc (Zn), titanium (Ti), vanadium (V), gallium (Ga), nickel (Ni), boron (B) and zirconium (Zr). The content of these elements in the aluminum alloy is preferably not more than 100 weight ppm, more preferably not more than 50 weight ppm.

It is preferable that the powder has an average particle diameter D₅₀ of 1 to 10 μm, particularly preferably 3 to 6 μm. The term “average particle diameter D₅₀” in the present specification designates a particle diameter corresponding to 50% (median value) of the entire particles in a particle size distribution curve that is obtained by finding a particle diameter and the number of particles having the diameter, using laser diffractometry.

There is no particular limitation on the shape of the powder; and a spherical, amorphous, scaly, fibrous, or other shape may be suitably used. A powder of spherical particles is particularly preferable.

A powder produced by a known method may be used as the powder described above. Examples of usable methods include an atomizing method, a melt spinning process, a rotating disk method, a rotating electrode process, and other rapid solidification processes. In terms of industrial production, an atomizing method, in particular, a gas atomizing method, is preferable. More specifically, a powder obtained by atomizing molten metal is preferably used.

In the present invention, the sintered body formed from powder comprises two or more sintered layers, and is structured such that, in adjacent sintered layers, the respective average particle diameters D₅₀ of the powders contained in the layers have a difference of at least 0.5 μm (preferably 1 to 6 μm). The sintered body may have a two-layer structure comprising a sintered layer formed of powder having an average particle diameter D₅₀ of 3 μm, and a sintered layer formed of powder having an average particle diameter D₅₀ of 4 μm. Examples of this structure are shown in Examples 1 and 2. Further, the sintered body may have a three-layer structure obtained by alternately laminating a sintered layer formed of powder having an average particle diameter D₅₀ of 3 μm, and a sintered layer formed of powder having an average particle diameter D₅₀ of 4 μm. One example of this structure is shown in Example 3.

Each sintered layer is preferably produced by sintering powder while keeping certain spaces between the particles. More specifically, as shown in the images of FIG. 2, the sintered layer preferably has a three-dimensional network structure in which the particles are connected to each other while having spaces therebetween. This porous sintered body ensures a desired capacitance without the need for etching.

The porosity of each sintered layer may be appropriately set to 30% or more according to desired capacitance, or the like. Further, the porosity may be controlled depending on, for example, the particle diameter of aluminum or aluminum alloy powder used as the starting material, or the formulation of the paste composition (resin binder) containing the powder.

In the present invention, the electrode material may further comprise a substrate that supports the electrode material.

The material of the substrate is not particularly limited, and may be selected from various metals, resins, etc. In particular, resins (resin film) are usable when only the sintered body remains following volatilization of the substrate. On the other hand, metal foils are preferred when the substrate remains. Among metal foils, aluminum foils are particularly preferable. In this case, the aluminum foil to be used may have substantially the same formulation as that of the sintered body, or may have a different formulation from that of the sintered body. Further, the surface of the aluminum foil may be roughened before forming the sintered body thereon. The surface-roughening method is not particularly limited; and any known technique, such as washing, etching, or blasting, may be employed.

There is no particular limitation on the aluminum foil used as a substrate. Pure aluminum or an aluminum alloy can be used. The composition of the aluminum foil used in the present invention may contain an aluminum alloy that contains a necessary amount of at least one alloy element selected from silicon (Si), iron (Fe), copper (Cu), manganese (Mn), magnesium (Mg), chromium (Cr), zinc (Zn), titanium (Ti), vanadium (V), gallium (Ga), nickel (Ni), and boron (B), or aluminum that contains a limited amount of the aforementioned elements as unavoidable impurities.

Although there is no particular limitation on the thickness of the aluminum foil, the thickness is preferably not less than 5 μm, and not more than 100 μm; and particularly preferably not less than 10 μm, and not more than 50 μm.

An aluminum foil produced by a known method can be used as the aluminum foil of the present invention. Such an aluminum foil can be obtained, for example, by preparing a molten metal of aluminum or an aluminum alloy of the above-mentioned composition, casting the molten metal to obtain an ingot, and subjecting the ingot to appropriate homogenization. The resulting ingot is then subjected to hot rolling and cold rolling to obtain an aluminum foil.

During the aforementioned cold rolling process, intermediate annealing may be conducted at a temperature within a range of not lower than 50° C. to not higher than 500° C., and particularly not lower than 150° C. to not higher than 400° C. After the cold rolling process, annealing may be conducted at a temperature range of not lower than 150° C. to not higher than 650° C., and particularly not lower than 350° C. to not higher than 550° C. to obtain a soft foil.

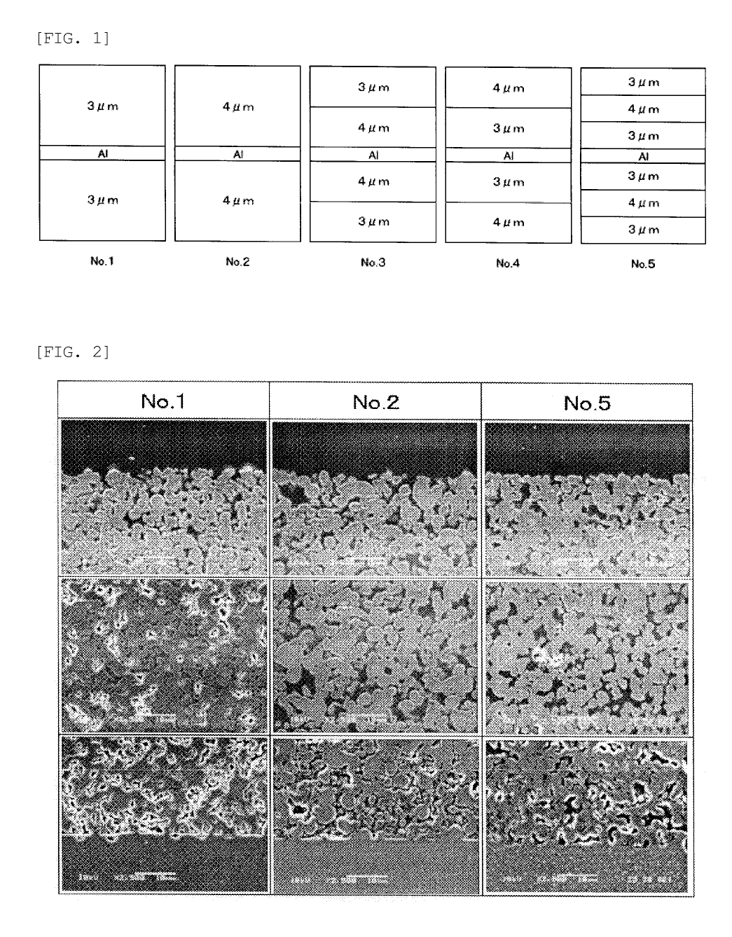

In the case of the substrate remaining, the sintered body may be formed on one side or both sides of the substrate. When forming the sintered body on both sides of the substrate, as shown in Nos. 3 to 5 of FIG. 1, the sintered bodies (and the sintered layers therein) are preferably symmetrically disposed.

The average thickness of the sintered body is preferably 35 to 500 μm. The average thickness of each sintered layer of the sintered body is preferably not less than 15 μm. These values are applied to both in the case of forming a sintered body on one side of the substrate and the case of forming sintered bodies on both sides of the substrate. However, in the case of forming sintered bodies on both sides of the substrate, the thickness of the sintered body on each side is preferably not less than ⅓ of the entire thickness (the thickness including the substrate). The average thickness of the sintered body is an average value obtained by measuring the thickness at seven points using a micrometer, and averaging the five values excluding the maximum and minimum values. Further, the average thickness of each sintered layer is found using three photos of cross sections of the sintered body; more specifically, using three pieces of approximately 200-times-magnified photos (enough magnification to take the entire cross section) taken by a scanning electron microscope. The average thickness is found as follows. In each photo, straight lines are drawn on the boundaries (visually determined) of the layers, and then the proportion of the thickness of each sintered layer is calculated; further, the aforementioned average thickness of the sintered body is multiplied by the proportion, thereby finding the thickness of each sintered layer. Then, the calculation values of three photos are averaged to determine the average thickness.

The electrode material of the present invention may be used as a low-voltage, medium-voltage or high-voltage aluminum electrolytic capacitor. In particular, the electrode material is suitable for use as a medium-voltage or high-voltage (medium- to high-voltage) aluminum electrolytic capacitor.

When used as an electrode for aluminum electrolytic capacitors, the electrode material of the present invention can be used without being subjected to etching. More specifically, the electrode material of the present invention may be used as an electrode (electrode foil) as is or by only being subjected to anodization, without the need for etching.

An electrolytic capacitor can be obtained by a process comprising: laminating an anode foil prepared by using the electrode material of the present invention, and a cathode foil with a separator therebetween; winding the laminate to form a capacitor element; impregnating the electrode with an electrolyte; and housing the capacitor element containing the electrode in a case; and sealing the case with a sealing material.

### 2. Method for Producing Electrode Material for Aluminum Electrolytic Capacitors

The method for producing the electrode material for aluminum electrolytic capacitors of the present invention has the following features.

The method comprises:

a first step of forming two or more layers of a composition comprising at least one of an aluminum powder and aluminum alloy powders on a substrate; and
a second step of sintering the layers at a temperature not lower than 560° C. and not higher than 660° C. The method does not comprise an etching step, and, in the first step, (i) the powder contained in each layer has an average particle diameter D₅₀ of 1 to 10 μm; and (ii) the sintered body is formed of two or more sintered layers in which average particle diameters D₅₀ of powders contained in adjacent sintered layers have a difference of at least 0.5 μm.

### First Step

In the first step, two or more layers of a composition comprising at least one of an aluminum powder and aluminum alloy powders are formed on a substrate. In the first step, (i) the powder contained in each layer has an average particle diameter D₅₀ of 1 to 10 μm; and (ii) the sintered body is formed of two or more sintered layers, and the average particle diameters D₅₀ of the powders contained in adjacent sintered layers have a difference of at least 0.5 μm (preferably 1 to 6 μm).

The formulation (component) of the aluminum or aluminum alloys may be one as mentioned above. For example, a pure aluminum powder having a purity of 99.8 wt % or more is preferably used as the powder.

The composition may contain, if necessary, resin binders, solvents, sintering aids, surfactants, etc. For these, known or commercially available products can be used. In particular, in the present invention, the composition is preferably used as a pasty composition comprising at least one member selected from the group consisting of resin binders and solvents. Using such a pasty composition enables the efficient formation of a film.

Resin binders are not limited, and suitable examples thereof include carboxy-modified polyolefin resins, vinyl acetate resins, vinyl chloride resins, vinyl chloride-vinyl acetate copolymers, vinyl alcohol resins, butyral resins, polyvinyl fluoride, acrylic resins, polyester resins, urethane resins, epoxy resins, urea resins, phenol resins, acrylonitrile resins, cellulose resins, paraffin wax, polyethylene wax, and other synthetic resins or waxes; and tar, glue, sumac, pine resin, beeswax, and other natural resins or waxes. These binders are divided into, depending on the molecular weight, the type of resin, etc., those that volatilize upon heating and those that remain as a residue together with aluminum powder as a result of pyrolysis. They can be used depending on the desired electrostatic characteristics, etc.

Moreover, any known solvents may be used. For example, water as well as organic solvents, such as ethanol, toluene, ketones, and esters, may be used.

The formation of a film may be performed, for example, by a method of forming a film of a paste composition by rolling, brushing, spraying, dipping or a like coating process, or by a known printing method such as silk-screen.

In the case of using a substrate, the two or more films may be formed on one side or both sides of the substrate. When forming the films on both sides of the substrate, the two or more films are preferably symmetrically disposed having the substrate therebetween.

The average thickness of the two or more films is preferably 35 to 500 μm. The average thickness of each film of the two or more films is preferably not less than 15 μm. These values are applied to both in the case of forming the films on one side of the substrate, and the case of forming the films on both sides of the substrate. However, in the case of forming the films on both sides of the substrate, the thickness of the films on each side is preferably not less than ⅓ of the entire thickness (including the substrate).

Each film may be dried at a temperature within a range of not lower than 20° C. to not higher than 300° C., if necessary.

### Second Step

In the second step, the film is sintered at a temperature not lower than 560° C. and not higher than 660° C.

The sintering temperature is not lower than 560° C. and not higher than 660° C., preferably not lower than 560° C. but lower than 660° C., and more preferably not lower than 570° C. and not higher than 659° C. The sintering time, which varies depending on the sintering temperature, etc., can be suitably determined generally within the range of about 5 to 24 hours.

The sintering atmosphere is not particularly limited, and may be any of a vacuum atmosphere, an inert gas atmosphere, an oxidizing gas atmosphere (air), a reducing atmosphere, and the like. In particular, a vacuum atmosphere or a reducing atmosphere is preferable. The pressure conditions may also be any of a normal pressure, a reduced pressure, and an increased pressure.

After the first step but prior to the second step, a heat treatment (degreasing treatment) is preferably conducted in such a manner that the temperature is maintained within the range of not lower than 100° C. to not higher than 600° C. for 5 hours or more. The heating atmosphere is not particularly limited; and may be, for example, any of a vacuum atmosphere, an inert gas atmosphere, and an oxidizing gas atmosphere. The pressure conditions may also be any of a normal pressure, a reduced pressure, and an increased pressure.

### Third Step

The electrode material of the present invention can be obtained in the second step described above. The electrode material can be directly used as an electrode (electrode foil) for an aluminum electrolytic capacitor without etching.

Alternatively, the electrode material of the present invention may be anodized in the third step, if necessary, to form a dielectric, which is used as an electrode.

Although there is no particular limitation on the anodization conditions, the anodization may typically be conducted by applying a current of about not less than 10 mA/cm² and not more than 400 mA/cm² to the electrode material for not less than 5 minutes in a boric acid solution with a concentration of not less than 0.01 mol and not more than 5 mol at a temperature of not lower than 30° C. and not higher than 100° C.

### EXAMPLES

The present invention is described in more detail below with reference to Comparative Examples and Examples. However, the scope of the present invention is not limited to these examples.

The electrode materials of the Comparative Examples and the Examples were prepared by the following procedure. The capacitances of the obtained electrode materials were measured as follows. After each electrode material was subjected to a chemical conversion treatment at 410 V in an aqueous boric acid solution (50 g/L), the capacitance was measured in an aqueous ammonium borate solution (3 g/L). The measured projected area was 10 cm².

### Comparative Example 1

60 parts by weight of an aluminum powder having an average particle diameter D₅₀ of 3 μm (JIS A1080, manufactured by Toyo Aluminium K.K., product number: AHUZ58FN) was mixed with 40 parts by weight of an ethylcellulose-based binder, and the mixture was dispersed in a solvent (ethyl cellosolve) to obtain a coating solution A having a solids content of 50 wt %.

The coating solution A was applied to both sides of a 30-μm-thick aluminum foil (JIS 1N30-H18, 500 mm×500 mm) by silk-screen, and the resulting film was dried. The application was performed by applying the coating solution A on one side of the foil to a thickness of 60 μm, followed by drying for 30 minutes in an oven at 150° C. Then, the same application and drying were performed on the other side of the foil. This process was repeated three times.

This sample was sintered in an argon gas atmosphere at a temperature of 650° C. for 7 hours, thereby producing an electrode material.

The thickness of the electrode material after sintering was about 390 μm.

Table 1 shows the capacitance of the obtained electrode material.

### Comparative Example 2

A coating solution B was obtained in the same manner as in Comparative Example 1, except that an aluminum powder having an average particle diameter D₅₀ of 4 μm (JIS A1080, manufactured by Toyo Aluminium K.K., product number: AHUZ58CN) was used instead of the aluminum powder having an average particle diameter D₅₀ of 3 μm.

An electrode material was obtained in the same manner as in Comparative Example 1, except that the coating solution B was used.

The thickness of the electrode material after sintering was about 390 μm.

Table 1 shows the capacitance of the obtained electrode material.

### Example 1

As shown in No. 3 in FIG. 1, an electrode material was obtained in the same manner as in Comparative Example 1, except that the coating solution A was applied and dried on one side of an aluminum foil to a thickness of 90 μm; the coating solution B was further applied and dried thereon to a thickness of 90 μm; the coating solution A was applied and dried on the other side of the aluminum foil to a thickness of 90 μm; and the coating solution B was further applied and dried thereon.

The thickness of the electrode material after sintering was about 390 μm.

Table 1 shows the capacitance of the obtained electrode material.

### Example 2

As shown in No. 4 in FIG. 1, an electrode material was obtained in the same manner as in Comparative Example 1, except that the coating solution B was applied and dried on one side of an aluminum foil to a thickness of 90 μm; the coating solution A was further applied and dried thereon to a thickness of 90 μm, the coating solution B was applied and dried on the other side of the aluminum foil to a thickness of 90 μm; and the coating solution A was further applied and dried thereon.

The thickness of the electrode material after sintering was about 390 μm.

Table 1 shows the capacitance of the obtained electrode material.

### Example 3

As shown in No. 5 in FIG. 1, an electrode material was obtained in the same manner as in Comparative Example 1, except that the coating solution B was applied and dried on one side of an aluminum foil to a thickness of 60 μm, the coating solution A was further applied and dried thereon to a thickness of 60 μm, the coating solution B was further applied and dried thereon to a thickness of 60 μm, the coating solution B was applied and dried on the other side of the aluminum foil to a thickness of 60 μm, the coating solution A was further applied and dried thereon to a thickness of 60 μm, and the coating solution B was further applied and dried thereon to a thickness of 60 μm.

The thickness of the electrode material after sintering was about 390 μm.

Table 1 shows the capacitance of the obtained electrode material.

TABLE 1

| | Compar- | Compar- | | | |
|---|---|---|---|---|---|
| | ative | ative | Example | Example | Example |
| | Example 1 | Example 2 | 1 | 2 | 3 |
| Capacitance | 4.40 | 4.05 | 4.75 | 4.65 | 4.90 |
| (μF/10 cm²) | | | | | |

Table 1 demonstrates that the examples (Examples 1 to 3) in which a sintered body was formed by forming two or more sintered layers having a difference in average particle diameter D₅₀ of 0.5 μm or more ensured a higher capacitance than the examples (Comparative Examples 1 and 2) in which a sintered body was formed by forming a single layer using an aluminum powder having an average particle diameter D₅₀ of 3 or 4 μm.

1-7. (canceled)

8. An electrode material for aluminum electrolytic capacitors using a liquid electrolyte, comprising a sintered body of at least one of an aluminum powder and aluminum alloy powders, wherein:
(1) the powder has an average particle diameter D50 of 1 to 10 μm,
(2) the sintered body comprises two or more sintered layers in which average particle diameters D50 of powders contained in adjacent sintered layers have a difference of at least 0.5 μm.

9. The electrode material for aluminum electrolytic capacitors, further comprising a substrate that supports the electrode material.

10. The electrode material for aluminum electrolytic capacitors according to claim 9, wherein the substrate is an aluminum foil.

11. The electrode material for aluminum electrolytic capacitors according to claim 9, wherein the sintered body is formed on each side of the substrate, and wherein:
(1) the sintered body formed on each side has a thickness of 35 to 500 μm, and
(2) each layer of the sintered body formed on each side of the substrate has a thickness of not less than 15 μm.

12. The electrode material for aluminum electrolytic capacitors according to claim 10, wherein the sintered body is formed on each side of the substrate, and wherein:
(1) the sintered body formed on each side has a thickness of 35 to 500 μm, and
(2) each layer of the sintered body formed on each side of the substrate has a thickness of not less than 15 μm.

13. A method for producing an electrode material for aluminum electrolytic capacitors using a liquid electrolyte, comprising,
(1) a first step of laminating two or more layers formed of a composition of at least one of an aluminum powder and aluminum alloy powders on a substrate; and
(2) a second step of sintering the two or more layers at 560° C. to 660° C.,
wherein the method does not comprise an etching step, and wherein (i) the powder contained in each of the layers has an average particle diameter D50 of 1 to 10 μm, and (ii) average particle diameters D50 of powders contained in adjacent sintered layers have a difference of at least 0.5 μm.

14. The method according to claim 13, wherein the two or more layers are formed on each side of the substrate.

15. The method according to claim 13, further comprising a third step of anodizing the two or more layers after sintering.

16. The method according to claim 14, further comprising a third step of anodizing the two or more layers after sintering.
